(19) United States
(12) Patent Application Publication
(10) Pub. No.: US 2024/0243909 A1
(43) Pub. Date: Jul. 18, 2024

(54) METHODS FOR SECURING AND ENCRYPTING SECRETS

(71) Applicant: Barbara Jean Wilk, Nesconset, NY (US)

(72) Inventor: Ryan Joseph Topps, Nesconset, NY (US)

(21) Appl. No.: 18/435,810

(22) Filed: Feb. 7, 2024

Related U.S. Application Data
(63) Continuation-in-part of application No. 16/396,367, filed on Apr. 26, 2019, now Pat. No. 11,917,061.

(51) Int. Cl. H04L 9/08

(52) U.S. Cl. CPC H04L 9/0861

(57) ABSTRACT

A method of cryptography includes generating three unique symmetric cryptographic keys; encrypting a first of the keys with a second of the keys and encrypting the second key with the third. The encrypted first key is then stored with the third key in a first computing storage area, while the encrypted second key is stored in a second computing storage area that is logically separate from the first computing storage area. A corresponding decryption process includes retrieving the encrypted first key and the third key from the first computing storage area; retrieving the encrypted second key from the second computing storage area; decrypting the encrypted second key with the third key; and decrypting the encrypted first key with the second key.

### CROSS-REFERENCE TO RELATED APPLICATIONS

This application is a continuation-in-part of U.S. patent application Ser. No. 16/396,367, filed Apr. 26, 2019, entitled “DECENTRALIZED AND/OR HYBRID DENCENTRALIZED SECURE CRYPOGRAPHIC KEY STORAGE METHOD,” the entire contents of which are incorporated herein by reference.

### BACKGROUND OF THE INVENTION

### 1. Field of the Invention

The present disclosure relates in general to cyber-security and more particularly to secure decentralized storage of cryptographic.

### 2. Background

A massive problem that has plagued cryptography since its inception is cryptographic key storage. Cryptographic key exchange problems were solved with the advent of public cryptography, but how to secure the private keys or symmetric keys still remain a problem. Centralization of key storage techniques has resulted in a single point of failure where attackers can focus their efforts. Thus, an ideal method would be a method that focuses on decentralization of key storage to remove this single point of failure. This will increase the security and privacy of end users who will hold the cryptographic keys.

### SUMMARY OF THE INVENTION

A hybrid-decentralized method for cryptography key storage is created that will be called mutual dependency architecture. This method uses a server, database, or device which users or devices of such system register with for authentication. The server, database, or device that performs such functions will be called the central authority. For ease of understanding, the backend of the central authority is extrapolated, since there is near indefinite possible implantations for such a system. The key storage is completely on the device end and sensitive components never touch the central authority. The basic scheme is creating a mutual dependency between the central authority and the device for the device to be able to “unlock” its stored keys.

In its most fundamental form, the scheme involves the production of three symmetric keys—an unlock key, a seed key, and a store key. The unlock key is encrypted by the seed key, which in turn is encrypted by the store key. Each of the three keys can be produced using any symmetric key algorithm, without specialized hardware. In an advanced form, a secret is encrypted by the unlock key before the unlock key is encrypted by the seed key. The various elements (ie. the three keys and the encrypted secret) are then separated and stored in two distinct logically separate computing storage areas, which may include RAM, cloud storage, hard drives, databases, and database rows. The store key and the encrypted unlock key are stored together in the first logical computing storage area, while the encrypted seed key and the encrypted secret (optional) are kept in the second logical computing storage area. These elements can be stored and accessed by any computing system and do not have to be used on the originating device or by the computing process that generated and encrypted the keys.

To access the unlock key or the optional secured secret, the various elements must be retrieved from the two separate logical storage areas. At this point, an optional authentication and authorization check may be performed to access these components from either storage area or from any remote computing system attempting to retrieve the components. Once all elements are gathered, the store key decrypts the encrypted seed key, which in turn decrypts the encrypted unlock key. Subsequently, the unlock key decrypts the optional encrypted secret. The unlock key can then be used as a standard encryption key, or the secret can be accessed and used for its designated purpose.

### BRIEF DESCRIPTION OF THE DRAWINGS

FIG. 1 is a visual description of the generation and encryption stage of a mutual dependency architecture scheme.

FIG. 2 is a visual description of the decryption stage of a mutual dependency architecture scheme.

FIG. 3 is a visual description of the storage stage of a mutual dependency architecture scheme.

FIG. 4 is a visual description of the retrieval stage of a mutual dependency architecture scheme.

FIG. 5 is a visual description of encryption and storage according to one example of a mutual dependency architecture scheme.

FIG. 6 is a visual description of retrieval and decryption in the mutual dependency architecture scheme of FIG. 5.

FIG. 7 is a visual description of encryption and storage according to an alternate example of a mutual dependency architecture scheme.

FIG. 8 is a visual description of retrieval and decryption in the mutual dependency architecture scheme of FIG. 7.

FIG. 9 is a visual description of a decentralized method of Mutual Dependency Architecture.

FIG. 10 is a visual description of a secure key exchange over a direct connection.

FIG. 11 is a visual description of how a permanently secure network of devices nodes can communicate when not directly connected.

FIG. 12 is a visual description of how devices can be removed or “blacklisted” from a permanently secure network of devices utilizing a master device only method.

FIG. 13 is a visual description of how devices can be removed or “blacklisted” from a permanently secure network of devices utilizing a reporting method.

FIG. 14 is a visual description of chain deployment.

FIG. 15 is a visual description of the concept of ad-hoc trusted third parties.

FIG. 16 is a visual description of the concept of relay encapsulation.

FIG. 17 is a visual description of a method of securely relaying and propagating a message through a decentralized permanently secure network created using the cryptographic key storage methods of the present disclosure.

### DETAILED DESCRIPTION OF THE PREFERRED EMBODIMENT(S)

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

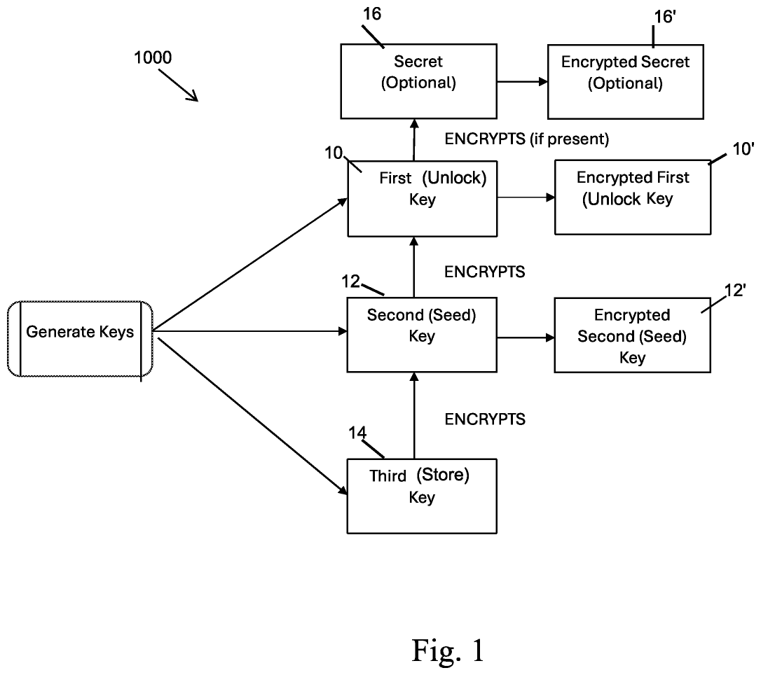

FIG. 1 shows a method 1000 of generating and encrypting keys. Initially, three symmetric keys—a first (unlock) key 10, a second (seed) key 12, and a third (store) key 14—are generated using any symmetric key algorithm, with no need for specialized hardware or public key cryptography algorithms. The first key 10, which may optionally have been used to encrypt a secret 16 (resulting in an encrypted secret 16¹), is encrypted by the second key 12, resulting in an encrypted first key 10¹. The second key 12 is encrypted by the third key 14, resulting in an encrypted second key 12¹.The third key 14 remains in its original, unencrypted or “naked” state (ie. as plain text). Generation and encryption of each key 10, 12, 14, and of the optional secret 16 can be performed in a variety of computing environments including, but not limited to, virtual machines, containers, and serverless functions, with no specialized hardware required.

The secret 16 can be any type of data that needs to be kept confidential. If there is no secret to encrypt (ie. the secret is a null set), the first key 10 may simply be used as a standard encryption key.

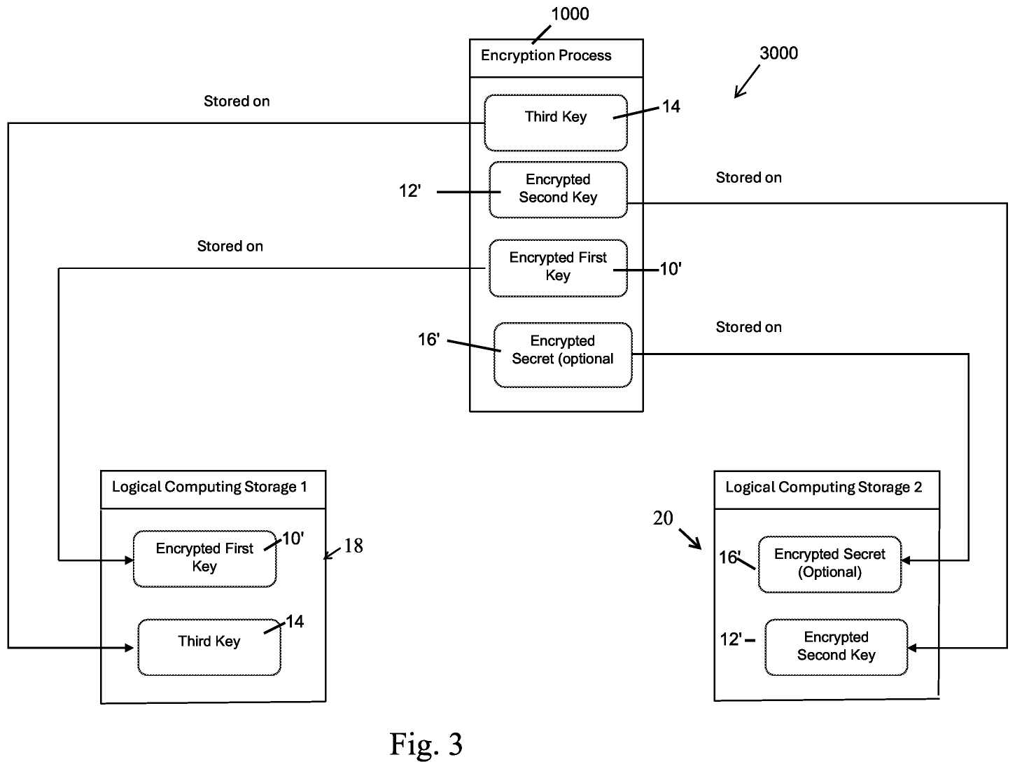

Once the three keys 10, 12, 14, and the optional secret 16 have been encrypted using the encryption process 1000, they are separated and stored using the storage process 3000 shown in FIG. 3 in two logically distinct computing storage areas 18, 20. The encrypted first key 10¹ is stored in the first computing storage area 18 together with the unencrypted (or “naked”) third key 14, while the encrypted second key 12¹ is stored in the second computing storage area 20 together with the optional encrypted secret 16¹. The two storage areas 18, 20 may include any type of computing storage such as RAM, cloud storage, hard drives, and databases or database rows, but must be logically separate from one another.

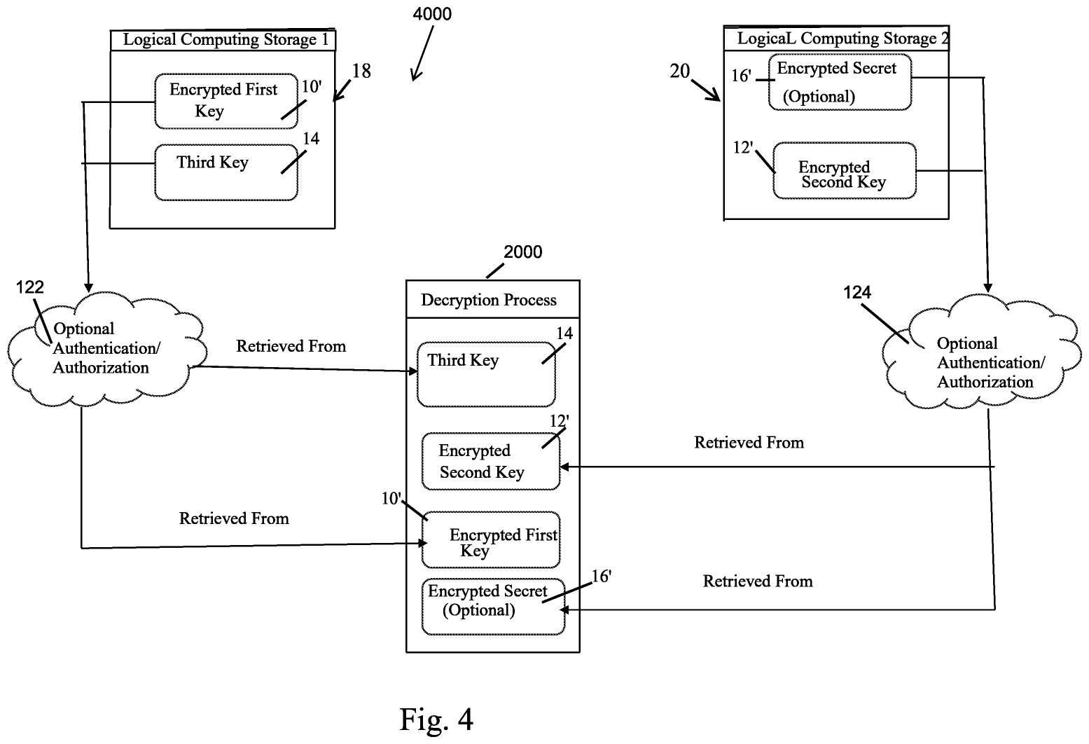

To access the unlock key 10 or the optional secret 16, the various elements must be retrieved from the two separate storage areas 18, 20. Specifically, the third key 14 and the encrypted first key 10¹ must be retrieved from the first storage area 18, and the encrypted second key 12¹ and optional encrypted secret 16 must be retrieved from the second storage area 20, as shown in the retrieval process diagram 4000 of FIG. 4. Optional authentication and authorization checks 22, 24 may be performed during retrieval from either storage area 18, 20.

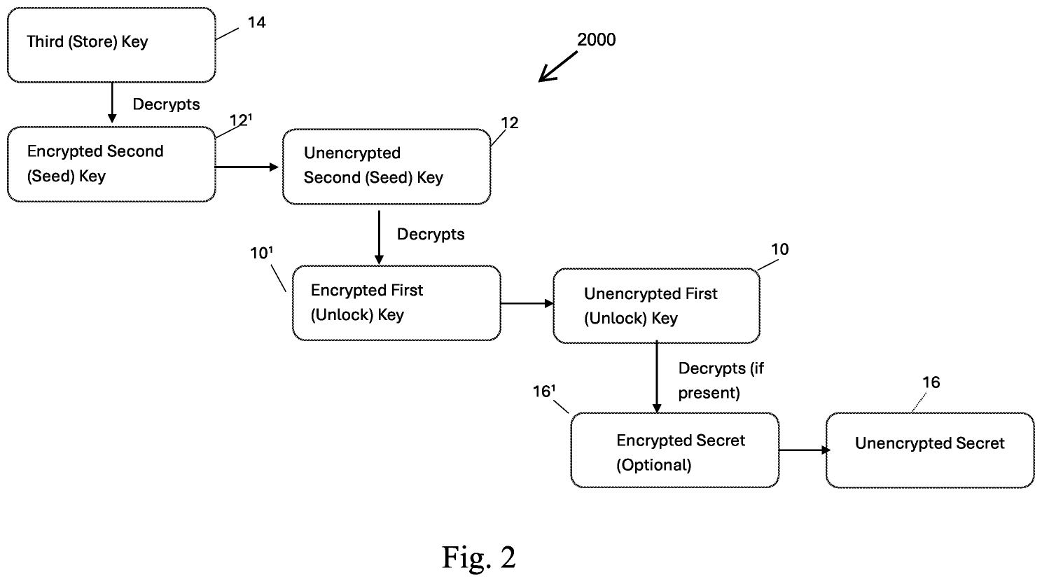

After the encrypted first and second keys 10¹, 12¹, the naked third key 14¹, and the optional encrypted secret 16¹ have been retrieved, the decryption process 2000 shown in FIG. 2 is applied. First, the encrypted second key 12¹ is decrypted by the third key 14. Next, the encrypted first key 10¹ is decrypted by the unencrypted second key 12. At this point, if there is an encrypted secret 16¹, it is decrypted by the unencrypted first key 10, making the unencrypted secret 16 accessible for its designated purpose. If there is no encrypted secret, the unencrypted first key 10 can be used as a standard encryption key.

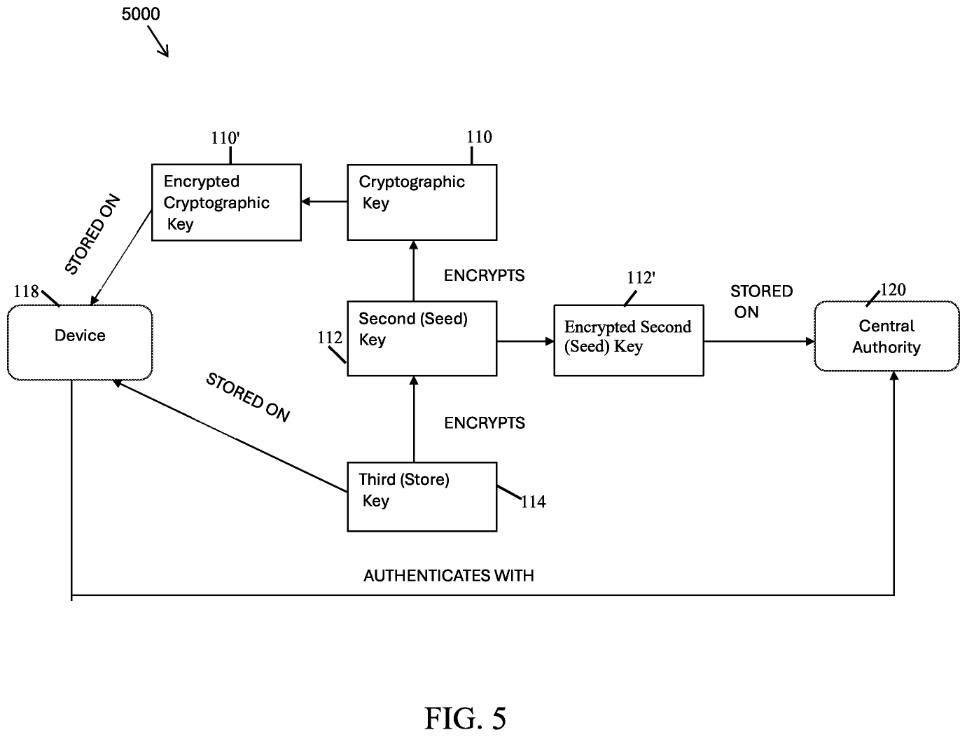

FIG. 5 shows an example of an encryption and storage process 5000 of the mutual dependency architecture scheme described above, wherein the first key (unlock) is a standard cryptographic key 110 for a device 118. The first key 110 is encrypted by the second key 112, and the resulting encrypted first key 110¹ is stored on the device 118. The second key 112 is encrypted by the third (store) key 114, and the resulting encrypted second key 112¹, also known as the encrypted seed, is transmitted to a central authority 120 requiring authentication with the device 118. The naked third key 114 is the stored with the encrypted first key 110 on the device 118, The amount of security available is dependent on how the central authority 126 is configured and how the authentication is handled. Suitable authentication methods for the central authority 126 may include, but are not limited to, basic username and password, OAuth2, biometrics, and various combinations thereof.

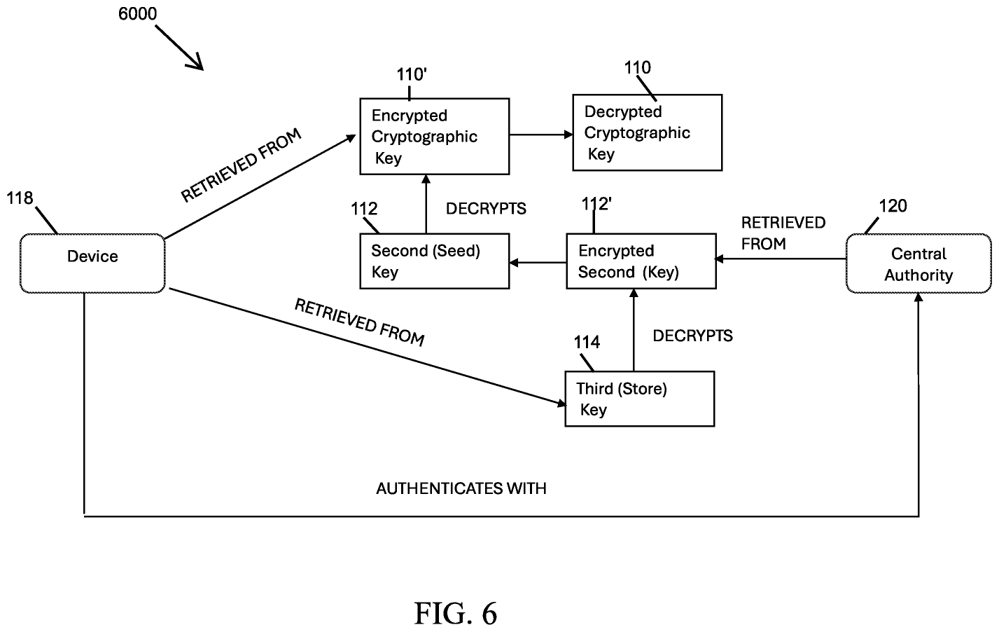

To retrieve the standard cryptographic key 110 using the retrieval and decryption process 6000 shown in FIG. 6, the device 118 must authenticate with the central authority 120 to retrieve the encrypted second key 112¹. The naked store key 114 then decrypts the encrypted second key 112¹, resulting in unencrypted second key 112, which is then used to decrypt the encrypted cryptographic key 110¹. The decrypted cryptographic key is then provided in its original form original form to an end user who requested the unlocking of the key.

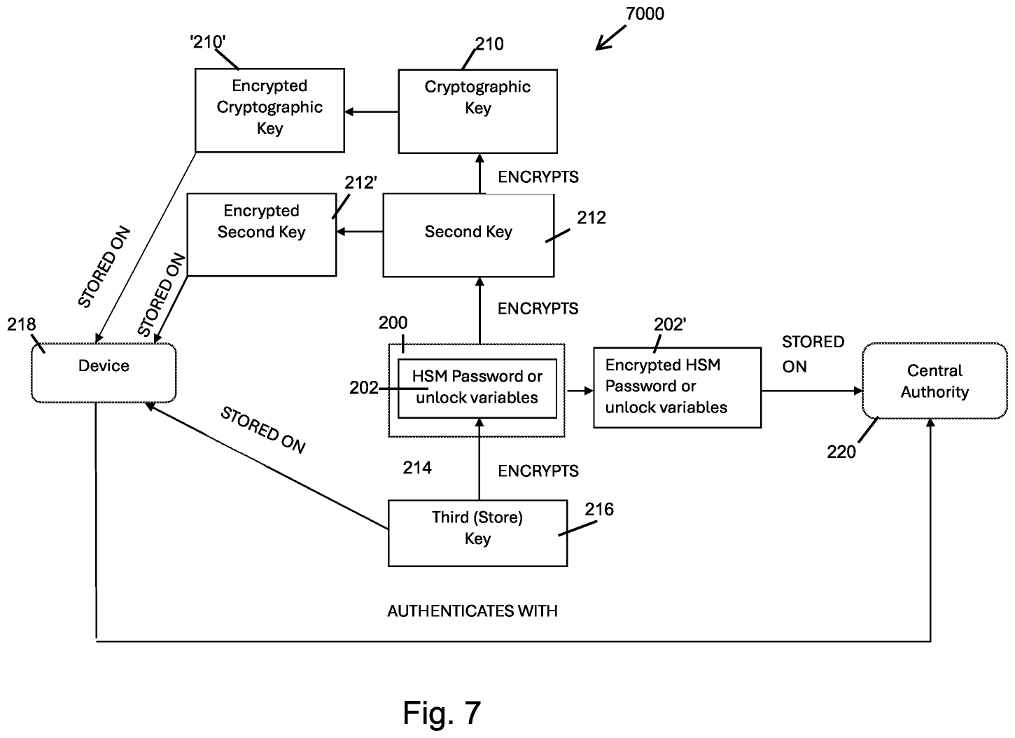

An alternative retrieval and storage scheme 7000 shown in FIG. 7 adds additional security components to increase the security. The architecture here is essentially the same as the architecture of the scheme 5000 shown in FIG. 5, except that the second key 212 is encrypted or “sealed” by a hardware security module 200 rather than by the third key 214, and the encrypted second key 212¹ is stored on the device 218 rather than on the central authority 220. The password or unlock variables 202 for the hardware security module (HSM) 200 are then encrypted, and the encrypted password or unlock variables 202¹ are stored on the central authority 220. The encrypted password or security variables 202¹ are then protected behind the authentication configured for the central authority 220 and not stored on the device 218. As in the scheme shown in FIG. 5, the original cryptographic key 210 is encrypted by the second key 212, and the encrypted cryptographic key 210¹ is stored with the unencrypted or “naked” third key 216.

This alternative encryption and storage scheme 7000 has several benefits as it truly binds the cryptographic key 210 to the device 218, since the physical HSM 200 is needed to decrypt the encrypted cryptographic key 210¹. Thus, an attacker must acquire the physical device 218 and access its storage, as well as breaching the central authority 220 to obtain the cryptographic keys 210 for device 218. Other alternative schemes utilizing variations of the same mutual dependency architecture could include, but are not limited to, other localized security methods such as keychain technology, secure device storage, and the like.

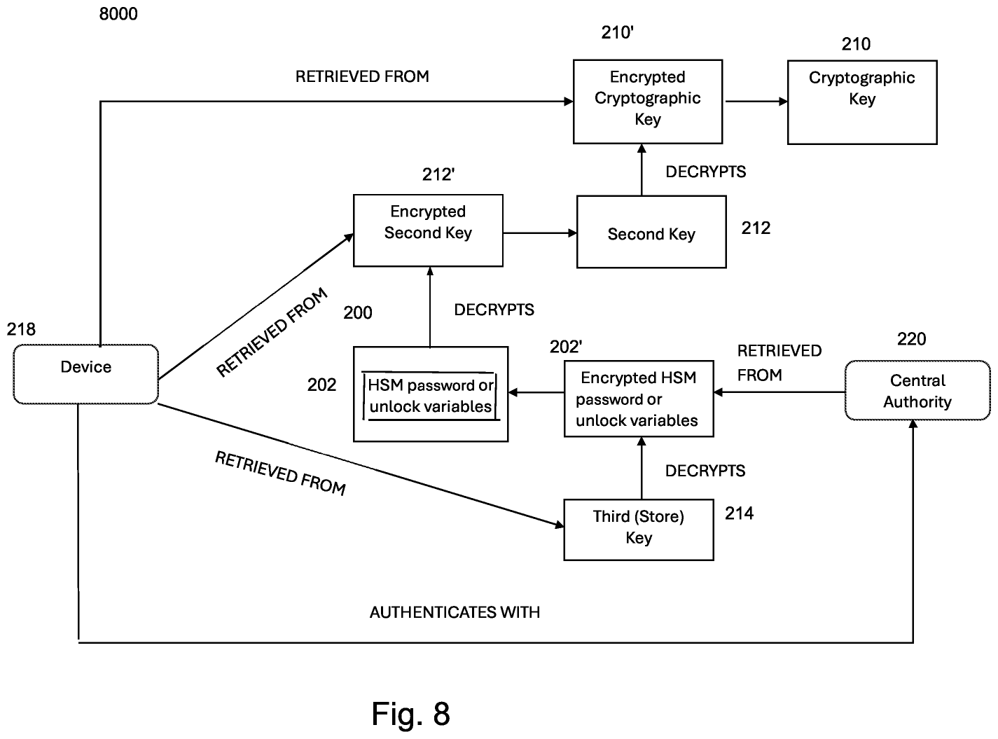

The retrieval and decryption scheme 8000 shown in FIG. 8 requires the device 218 to authenticate with the central authority 220, and retrieve the encrypted HSM password or security variables 202¹. The third key 214 then decrypts the encrypted HSM password or security variables 202¹, allowing the HSM 200 to decrypt the encrypted second key 212′¹ using the decrypted password or security variables 202. The second key 212 then decrypts the encrypted cryptographic key 210′, which is in turn provided in its original form to an end user who requested the unlocking of the cryptographic key 210.

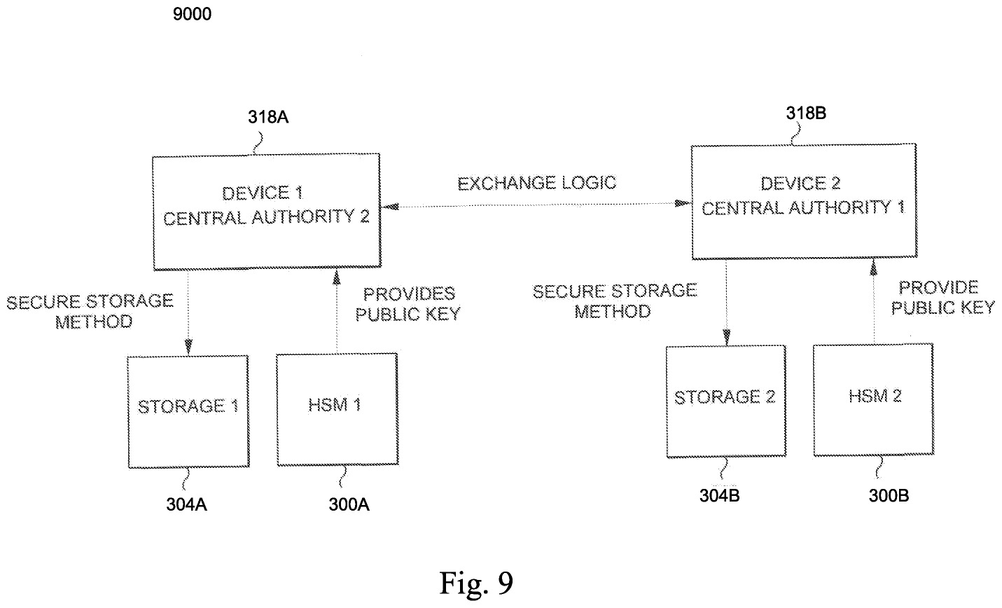

One example of a system using the principles of mutual dependency architecture for peer-to-peer use and implementation is shown in FIG. 9. The system 9000 includes a first device 318A having a first HSM 300A and a first storage module 304A, and a second device 318B having a second HSM 300B and a second storage module 304B. Each HSM contains a public key cryptography system for storing session keys after exchange and use, enabling session key exchanges using the Diffie-Hellman key exchange method. After session keys are no longer needed, they are encrypted and stored using the method described above in connection with FIG. 7, except that each device acts as the central authority for the other device.

A method of decentralized peer-to-peer authentication and key storage using the system of FIG. 9 involves the following steps:
1) The HSM for the first device 318A supplies its public key to the first device 318A and the HSM for the second device 318B stores its public key to the second device 319.
2) The first device 318A and the second device 318B commence a secure key exchange.
3) The first device 318A encrypts the session key for the second device 318B using a first unlock key, and the second device encrypts the session key for the first device 318A using s second unlock key.
4) The first unlock key is encrypted using the HSM for the first device 318A, creating a first encrypted seed, and the second unlock key is encrypted using the HSM for the second device 318B, creating a second encrypted seed.
5) The first encrypted seed is stored on the first device 318A and the second encrypted seed is stored on the second device 318B.
6) The authentication key for the HSM for the first device 318A is encrypted using a first store key, and the authentication key for the HSM for the second device 318B is encrypted using a second store key.
7) The encrypted authentication key for the first device 318A is stored on the second device 318B, and the encrypted authentication key for the second device 318B is stored on the first device 318A.

The method described above is beneficial since the devices 318A and 318B can simply exchange the encrypted seeds and reuse the session keys if communications are to be reopened. The encrypted seeds could be also exchanged using the Diffie-Hellman method and any risk of a man in the middle attack on the reopening is nullified, since the exchange data is no longer a key, but just encrypted data that is only relevant to the talking devices. Furthermore, there can also be additional authentication steps, such as returning the signature of random of data that is sent encrypted with the requesting device's public key to prove ownership of the public key pair, and thus the encrypted seed. For the authentication steps, the devices could also store each other's public keys after the initial key exchange and use the stored public key as identifiers.

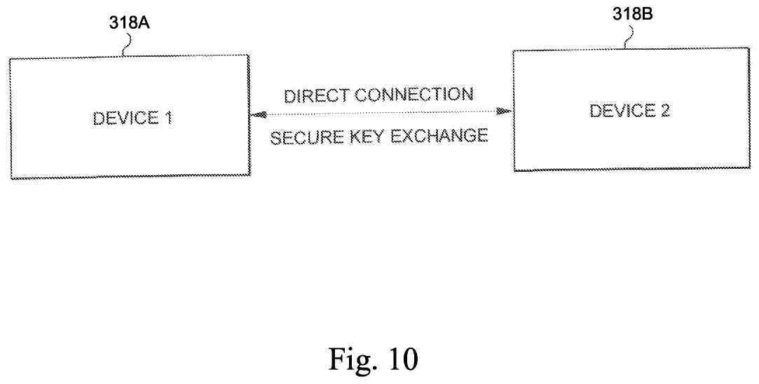

The decentralized peer-to-peer method described above may also be further developed to create a permanent secure network that provides a secure environment for the initial key exchanges between all devices in the network. Such a network may be formed as shown in FIG. 10, by: 1) creating a secure connection between a first device 318A and a second device 318B; and 2) initiating a secure key exchange between the two devices 318A, 318B using the Diffie-Hellman method. Once the key exchanges have occurred, both devices 318A, 318B have permanent secure communications with each other.

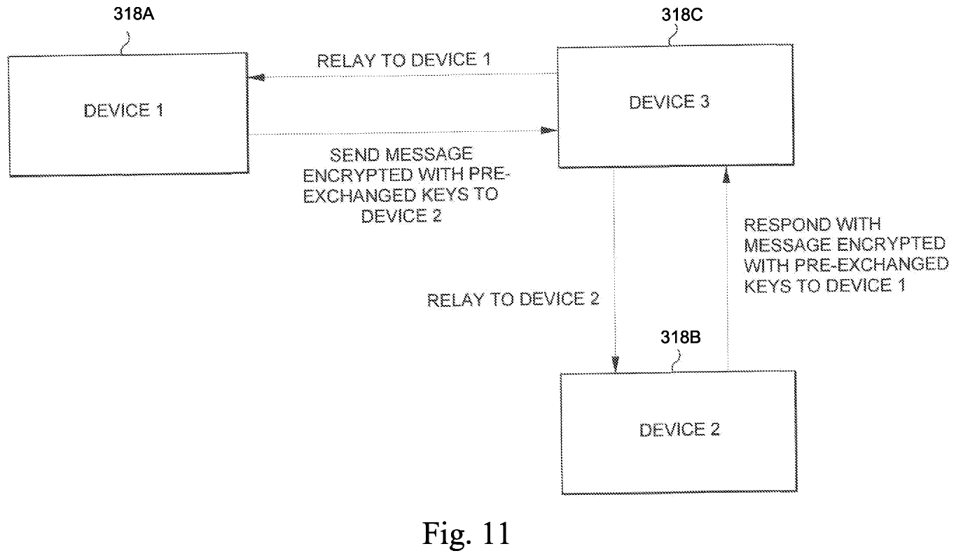

A method of securely propagating a message through a network formed by the method of FIG. 10 is depicted in FIG. 11 where the first device 318A and second device 318B have previously been paired using the method described above, and a third device 318C acts as an intermediary. Since the first and second devices 318Am 318B are pre-paired, communications can be started as though it is in the middle of an encrypted session. The method of FIG. 1 includes the following steps:
1) The first device 318A encrypts the message using the session key it received from the second device 318B.
2) The first device 318A sends the encrypted message to the third device 318C, which in turn relays the message to the second device 318B.
3) The second device 318B re-encrypts the message using the session key it received from the first device 318A.
4) The second device 318B sends the re-encrypted message to the third device 318C, which in turn relays the message to the first device 318A.

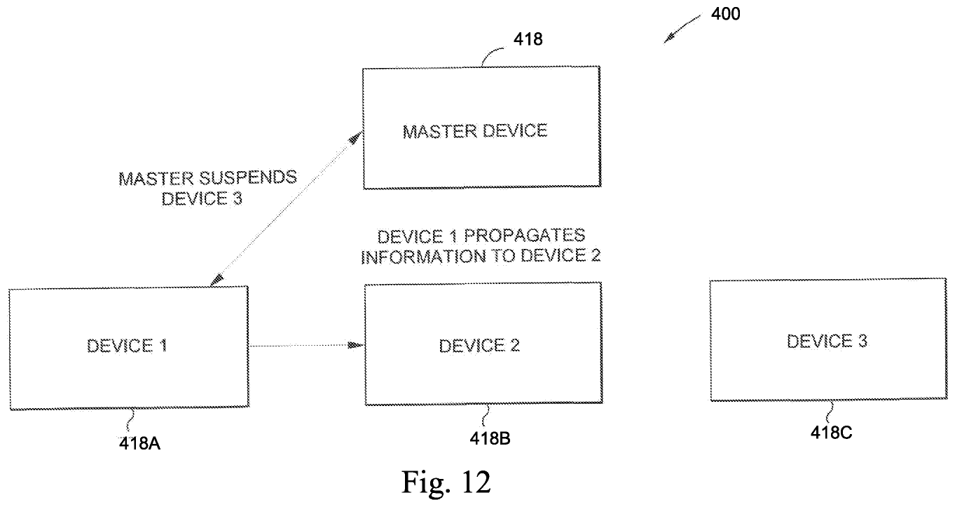

If a network device is lost or taken by a malicious user, that device can simply be excluded or “blacklisted” by the network, and the ability to view its previous conversations will be impossible unless the user also acquires another device from the network. The blacklisting process could be achieved by issuing a command that a public key is invalid through a master device, which will be relayed to all devices throughout the network. The basic schema of this blacklisting or invalidation method is depicted in FIG. 12, which shows a network 400 including a master device 418A and three subsidiary devices. The three subsidiary devices include a first subsidiary device 418A that is directly connected to the master device 418, a second subsidiary device 418B that can communicate with the first subsidiary device 418A, and a third subsidiary device 418C that has been lost or stolen. Each of the subsidiary devices 418A, 418B, and 418C has its own public key, and the master device 418 is capable of invalidating each of these public keys. When the master device 418 is notified that the third subsidiary 418C device has been lost or stolen, it invalidates the public key for the third subsidiary device 418C and notifies the first subsidiary device 418A that the third subsidiary device 418C is no longer a valid network device. The first subsidiary device 418A then relays this information to the second subsidiary device 418B.

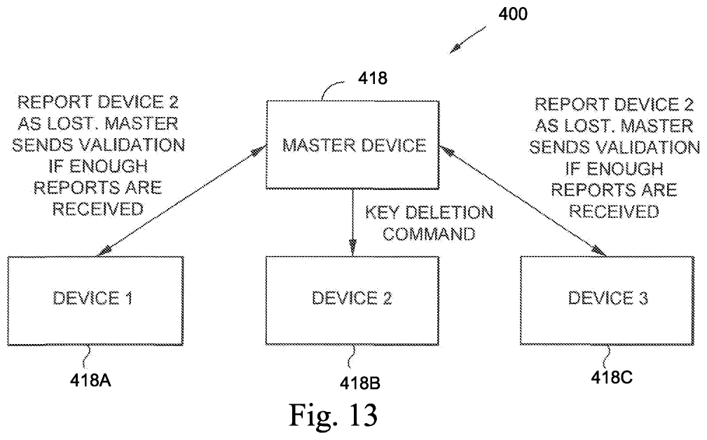

A decentralized approach could also be taken where the submittal of multiple “reports” by trusted network devices that a network device is compromised will result in the invalidation of the reported device's public key. This method is depicted in FIG. 13, which shows the same network 400 as FIG. 12, but where the second auxiliary device 418B, rather than the third auxiliary device 418C, has been lost, stolen, or captured by malicious users. In this scenario, the first auxiliary device 418A and the third auxiliary device 418C report the loss of the second auxiliary device 418B to the master device 418. When the master device 418 receives a threshold number of reports that the second auxiliary device 418B has been lost, it attempts to render the second auxiliary device 418B inoperative by issuing it a “delete keys” command. The master device 418 then sends invalidation reports to all other devices in the network, using the method described in relation to FIG. 12.

In a hybrid approach, the validity of a reported device's public key can be suspended until it is either permanently revoked by the master device 418 or overridden as valid. In addition, a system could be implemented wherein the master device is identified as compromised if it issues commands on devices that have not been reported by other devices (ie. it reports a device as stolen when no other device has reported that device stolen. This kind of system would be excellent for communicating time-sensitive data where past transmissions have an expiration of their usefulness, since there is vulnerability that previous communications can be seen if the two devices are captured. Granted that such vulnerabilities may be mitigated by device security mechanisms such as and not limited to biometrics, dual factor authentication, etc., which may prevent the captured devices from being used to begin with.

In some situations, it may be necessary to replace a device in a network, or to do a rolling deployment of a network when a new generation of devices has been introduced. In these situations, it is desirable to create an ad-hoc trusted third party.

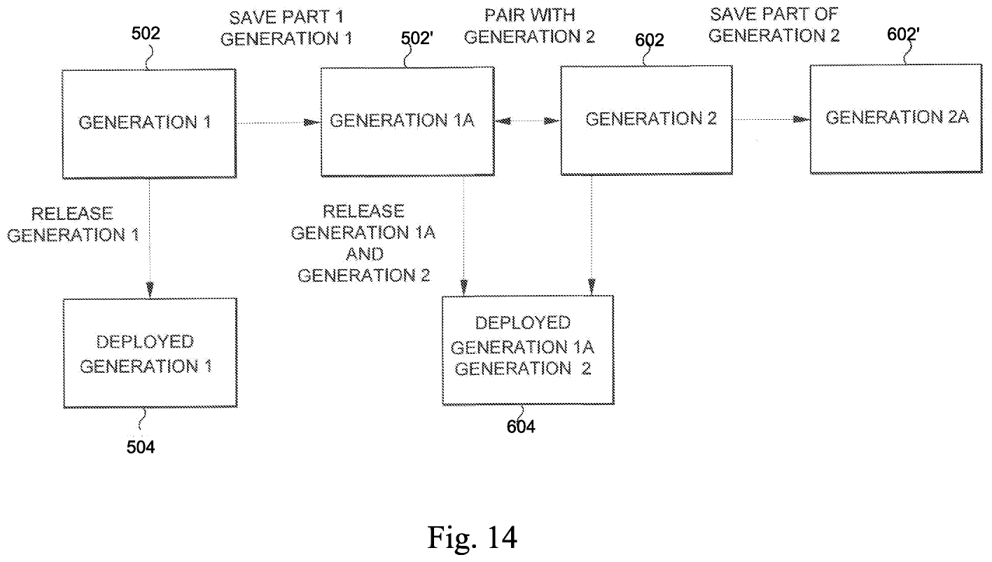

One method of deploying a decentralized, permanently secure ad-hoc network is shown in FIG. 14. When a first generation 502 of devices is released, all the devices in that generation exchange session keys using a secure pairing method. A first subset of the first generation is deployed to create a first network 504 consisting entirely of first generation devices, while a second subset 502¹ of the first generation is held in reserve. When a second generation 602 is released, each device in the second generation 602 exchanges exchange session keys with at least one other device in the second generation 602 and at least one device from the second subset 502¹ of the first generation using a secure pairing method. A first subset of the second generation 602 is then deployed with the second subset 502¹ of first generation devices to create an ad-hoc second network 604 consisting of both first and second generation devices. A second subset 602¹ of the second generation is held in reserve for pairing with a future third generation.

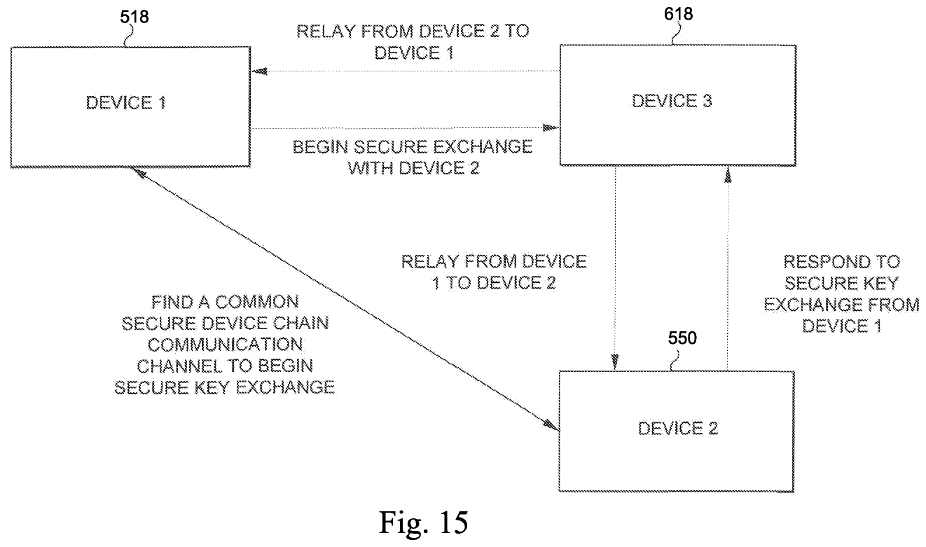

FIG. 15 shows a method for preventing “man in the middle” attacks on an ad hoc network created by the method of FIG. 14. In this scenario, when a second generation device 618 encounters a first generation device 704 it has not exchanged keys with, each device will search for third device 550 that has already exchanged session keys with both devices. Once both the second generation device 618 and the first generation device 518 determine that the third device 550 has previously exchanged keys with both, they designate the third device 550 as a trusted third party. The first and second generation devices 518, 618 then commence a secure key exchange, using the third device 550 as a communication channel. Once the keys are stored and the exchange is completed, second generation device 618 and first generation device 518 can both act as trusted third party for other devices. This method will be referred to hereafter as “chained deployment.”

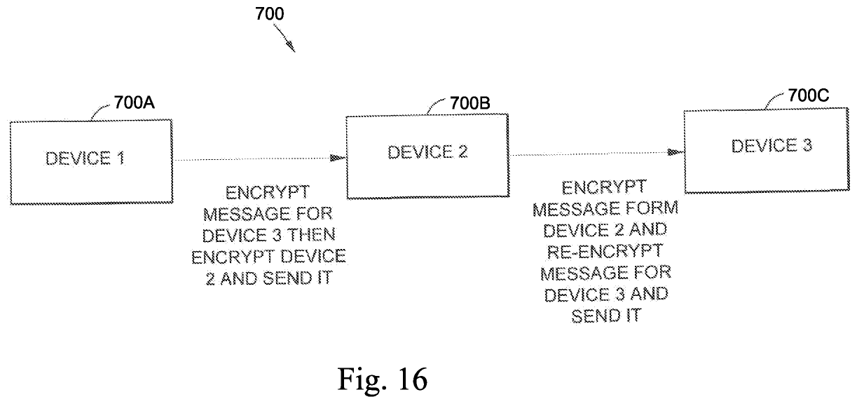

Communication among the devices of FIGS. 14 and 15 is kept secure using a method, referred to here as “relay encapsulation”, which is depicted in FIG. 16. For the sake of simplicity, the method is illustrated here in relation to a network 700 comprising three devices: a first device 700A, a second device 700B, and a third device 700C, where the first device 700A is directly connected to, and has previously swapped session keys with, the second device 700B, and the second device 700B is directly connected to, and has previously exchanged session keys with, the third device 700C, and where the third device 700C is distant from, or not directly connected to, the first device 700A.

The method for propagating an original message M₀ through the three-device network 700 of FIG. 16 is as follows:
1) The first device 700A and the third device 700C exchange session keys.
2) The first device 700A computes a secure hash of the original message M₀ and appends it to the secure hash of the original message M₀ to create an augmented message M_{1A} having a data section and a hash section.
3) The augmented message M_{1A} is encrypted in the first device 700A using the session keys exchanged between the first device 700A and the third device 700C (S1(3)) to create an encrypted augmented message M_{1B}.
4) The encrypted augmented message M_{1B} is encrypted using the session keys exchanged between the first device 700A and the second device 700B (S1(2)) to create a double-encrypted augmented message M_{1C}.
5) The double-encrypted augmented message M_{1C} is transmitted to the second device 700B.
6) The second device 700B decrypts the double-encrypted augmented message M_{1C} using the session keys exchanged between the first device 700A and the second device 700B (S1(2)) to create a single-encrypted augmented message M_{2B}.
7) The second device 700B encrypts the single-encrypted augmented message M_{2B} using the session keys exchanged between the second device 700B and the third device 700C (S2(3)).
8) The second device 804 transmits the single-encrypted augmented message M_{2B} to the third device 700C.
9) The third device decrypts the single-encrypted augmented message M_{2B} twice to receive the plain text original message M₀ and verifies its validity by calculating and comparing the decrypted hash and the computed hash.

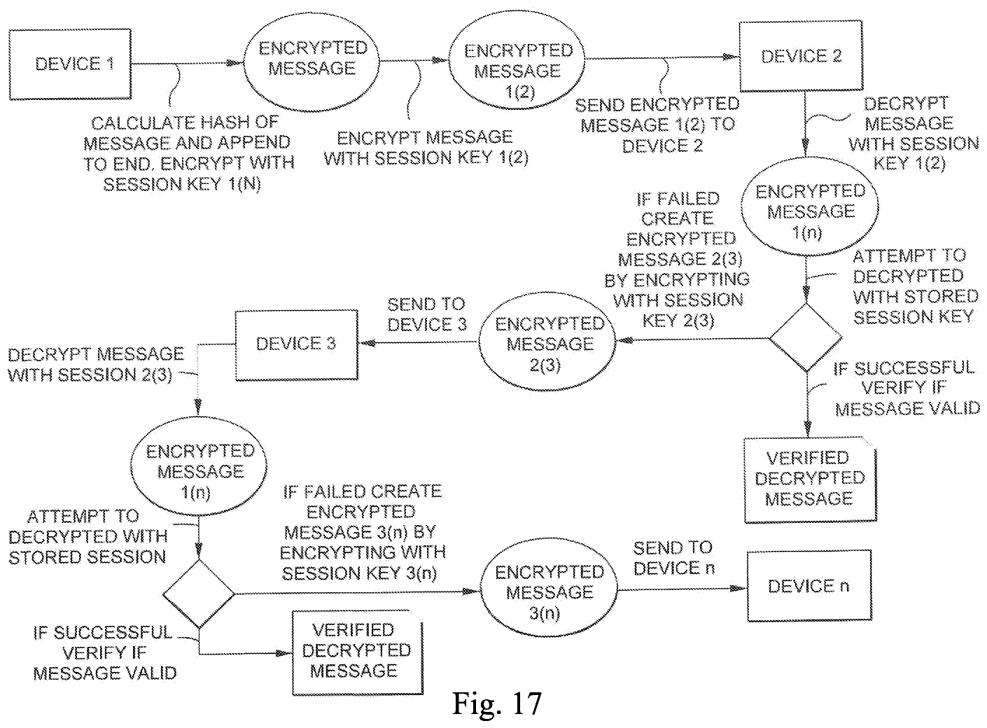

The method of FIG. 16 can readily be extrapolated to a longer chain of devices D1-Dn, wherein each device Dx has previously exchanged session keys with a subsequent device Dx+1 so that the first device D1 contains the session key S1(2) for the second device D2; every device Dx between the first device D1 and the last device Dn contains the session key Sx(x−1) for a previous device Dx−1 and the session key Sx(x+1) for a subsequent device Dx+1; and the end device Dn contains the session key Sn(n−1) for the penultimate device Dn−1. The method for propagating messages through the longer chain of devices is the same as for the three-device chain, except that a verification step is added at each device to verify whether the endpoint of the transmission has been reached, as shown in the flow chart of FIG. 17. The verification step consists of: attempting to decrypt the single-encrypted augmented message with all stored session keys to create a set of possible messages; computing a hash of the data section of each of the messages; and comparing the hash on the data section of each message with its hash section. If the hash on the data section of any message is the same as the hash of that message, the endpoint has been reached. If not, the single-encrypted augmented message must be re-encrypted and transmitted to the next device, where the entire process is repeated.

In some cases, the initial encapsulation step of this method can be skipped, since the messages can be viewed by the relaying devices without risking a security breach.

There are many ways the concept of chained deployment described in connection with FIG. 15 can be deployed. An algorithm or a neural net could determine the ideal exchange pairing per deployment of devices and apply this information to future deployments. For example, an algorithm or neural net may find that the devices that have been held in reserve from the first generation of devices should be spread out over the next five subsequent generations, since as each deployment of devices can differ. This optimization and chain deployment shows that a permanently secure network utilizing mutual dependency architecture need not be static and can adapt to new devices, and lost devices as well, as it is continuously expanded. Mutual dependency architecture allows upgrades to ciphers or other components of the devices to be performed on a rolling basis, since the cryptographic keys stored do not need to be of a single cipher.

An alternative method of deployment, referred to here as “proximity propagation deployment, operates on the assumption that all direct connections are “secure” and performs the initial key exchanges using the method described in connection with FIG. 6. Once all the localized pairs have exchanged their session keys, any device within the subnet can be tied to a secure chain of ad-hoc trusted third parties using the method described in connection with FIG. 15. Furthermore, when combined with chained deployment of networking gear, such as switches and routers, propagation can continue to pair routers and switches as needed to create a network with the capabilities needed. Alternatively, the networking gear can simply propagate with its nearest connection. Once propagation is finished, two devices on separate subnets can now begin key exchanges through a chain of ad-hoc trusted third parties. A permanent secure session can be established, or rather for efficiency, the session key can be discarded when its use is no longer needed. A permanent secure session does not need a chain of ad-hoc trusted third parties and can go the most direct route as man in the middle attacks are completely negated.

If a node of the network is malicious or captured, the chain of ad-hoc trusted third parties may become vulnerable to a man-in-the-middle attack. This can be mitigated by chained deployment of “master” servers, which can function as domain name servers. Those master servers could also utilize a form of block chain to create a master ledger of devices and their corresponding identities. Users will register their server's embedded public keys with the master servers so all connecting devices will know what public key to expect from the server response.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of encryption, comprising:
generating a first unique symmetric cryptographic key using a symmetric key cryptography algorithm;
generating a second unique symmetric cryptographic key using a symmetric key cryptography algorithm;
generating a third unique symmetric cryptographic key using a symmetric key cryptography algorithm;
using the second cryptographic key to encrypt the first cryptographic key via a symmetric key algorithm;
using the third cryptographic key to encrypt the second cryptographic key via a symmetric key algorithm;
storing the third cryptographic key and the encrypted first cryptographic key in a first computational storage space;
storing encrypted second cryptographic key in a second computational storage space that is logically separate from the first computational storage space.

2. The method of claim 1, further comprising:
using the first symmetrical key to encrypt a secret; and
storing the encrypted secret in the second computational storage space with the encrypted second cryptographic key.

3. The method of claim 1, wherein the first, second, and third cryptographic keys are generated independently of hardware cryptographic modules and public key cryptography algorithms.

4. The method of claim 1, wherein the encryption of the first and second keys is implemented by algorithms operable in any computational environment, devoid of specialized hardware.

5. The method of claim 2, wherein the encryption of the secret is implemented by an algorithm operable in any computational environment, devoid of specialized hardware.

6. The method of claim 2, further comprising recovering the secret by:
retrieving the third cryptographic key and the encrypted first cryptographic key from the first computational storage area;
retrieving the encrypted secret and the encrypted second cryptographic key from the first computational storage area;
decrypting the encrypted second cryptographic key using the third cryptographic key via a symmetric key algorithm;
decrypting the encrypted first cryptographic key using the second cryptographic key via a symmetric key algorithm; and
decrypting the secret using the first cryptographic key.

7. The method of claim 6, wherein the decryption of the first and second keys and the secret is implemented by algorithms operable in any computational environment, devoid of specialized hardware.

8. The method of claim 7, wherein recovery of the secret is requested by a user, and further comprising authorizing and authenticating the user during retrieval of the cryptographic keys.

9. A method for deploying a decentralized, permanently secure ad-hoc network, comprising:
acquiring a first generation of devices from a product line having a lifespan;
using a secure pairing method to pair each device in the first generation of devices with at least one other device in the first generation of devices to allow secure communications among the entire first generation of devices;
deploying a subset of the devices in the first generation of devices, while leaving behind a remainder of the first generation of devices;
acquiring a second generation of devices from the same product line;
using the secure pairing method to pair each device in the second generation of devices with at least one other device in the second generation of devices and at least one device in the remainder of the first generation of devices;
deploying a subset of the devices in the second generation of devices, while leaving behind a remainder of the second generation of devices; and
repeating for the lifespan of the product line.

10. The method of claim 9, wherein using a secure pairing method to pair each device in the first generation of devices with at least one other device in the first generation of devices comprises using the secure pairing method to pair all the devices in the first generation of devices with one another.

11. The method of claim 9, wherein using a secure pairing method to pair each device in the first generation of devices with at least one other device in the first generation of devices comprises using the secure pairing method to strategically pair each device with at least one other device.

12. The method of claim 9, wherein each device requires authentication.

13. The method of claim 12, wherein using a secure pairing method to pair each device in the first generation of devices with at least one other device in the first generation of devices comprises:
encrypting a first cryptographic key for a first device using a first seed key;
encrypting a second cryptographic key for a second device using a second seed key;
encrypting the first seed key using a first store key to create a first encrypted seed;
encrypting the second second key using a second store key to create a second encrypted seed;
storing the first encrypted seed on the second device;
storing the second encrypted seed on the first device;
storing the first store key and the first encrypted cryptographic key on the first device; and
storing the second store key and the second encrypted cryptographic key on the second device.

14. The method of claim 12, wherein using a secure pairing method to pair each device in the first generation of devices with at least one other device in the first generation of devices comprises:
associating a first device with a first hardware security module having a first authentication key;
associating a second device with a second hardware security module having a second authentication key;
encrypting a first cryptographic key for the first device using a first seed key;
encrypting a second cryptographic key for the second device using a second seed key;
encrypting the first seed key using the first hardware security module;
encrypting the second seed key using the second hardware security module;
encrypting the first authentication key using a first store key;
encrypting the second authentication key using a second store key;
storing the encrypted first cryptographic key, the encrypted first seed key, the first store key, and the second authentication key in the first device; and
storing the encrypted second cryptographic key, the encrypted second seek key, the second store key, and the first authentication key in the first device.
